(19) United States
(12) Patent Application Publication
(10) Pub. No.: US 2012/0057195 A1
(43) Pub. Date: Mar. 8, 2012

(54) IMAGE FORMING APPARATUS AND IMAGE FORMING METHOD

(75) Inventor: Norihisa Shiraishi, Shizuoka (JP)

(73) Assignee: TOSHIBA TEC KABUSHIKI KAISHA, Tokyo (JP)

(21) Appl. No.: 13/208,468

(22) Filed: Aug. 12, 2011

(30) Foreign Application Priority Data
Sep. 3, 2010 (JP) 2010-197939

(51) Int. Cl. G06F 3/12

(52) U.S. Cl. 358/1.15

(57) ABSTRACT

Embodiments described herein are directed to an image forming apparatus and an image forming method. The image forming apparatus includes a feeding mechanism, an image forming unit, and a control unit. The feeding mechanism is configured to feed a recording medium. The image forming unit is configured to form an image on the recording medium. The control unit is configured to calculate a duty cycle for a print data unit and control the image forming unit to form the image based on the calculated duty cycle, thereby reducing electrical power consumption for forming the image. The image forming method includes generating, if the duty cycle for the print data unit is greater than a predetermined value, a culling mask pattern, converting image data of the print data unit with the culling mask pattern, and forming the image using the converted image data in the recording medium.

### CROSS-REFERENCE TO RELATED APPLICATION

This application is based upon and claims the benefit of priority from Japanese Patent Application No. 2010-197939, filed on Sep. 3, 2010, the entire contents of which are incorporated herein by reference.

### FIELD

Embodiments described herein relate generally to an image forming apparatus such as a printer and an image forming method of the image forming apparatus.

### BACKGROUND

The amount of electrical power consumed by an image forming apparatus such as a printer is sometimes pre-allocated. For example, when an image forming apparatus is operated in conjunction with or as a part of an information processing terminal, the amount of electrical power allocated to the image forming apparatus may be preset.

In some instances, if the image forming apparatus converts print data received from a host computer to a printable image without any resolution reduction, the image forming apparatus may consume more electrical power than the pre-allocated amount of electrical power when printing an image at a high print density. If the image forming apparatus consumes more electrical power than the pre-allocated electrical power, it may cause a reduction in power source voltage supplied to the information processing terminal. In a worst case scenario, the entire system may shutdown due to a shortage of electrical power.

In view of the problem as described above, when performing double-sided printing, a technique has been proposed for preventing a thermal head from printing simultaneously on a front surface and a rear surface. Instead, a time shift is implemented so that the thermal head prints first on a front surface and then on a back surface.

However, when a graphic image such as a photograph is printed through such a technique, some portion of the graphic image may not be printed.

### BRIEF DESCRIPTION OF THE DRAWINGS

FIG. 1 is a block diagram showing a configuration of an image forming apparatus.

FIG. 2 is a flowchart explaining the operation of the image forming apparatus.

FIG. 3 is a diagram showing an example state of printing dots prior to performing a culling operation.

FIG. 4 is a diagram showing an example of a culling mask pattern.

FIG. 5 is a diagram showing another example of a culling mask pattern.

FIGS. 6A and 6B are diagrams showing a first conduction time shortened by a certain percentage of a normal conduction time and a printing pattern during the first shortened conduction time, respectively.

FIGS. 7A and 7B are diagrams showing a second conduction time shortened by a certain percentage of the normal conduction time and a printing pattern during the second shortened conduction time, respectively.

FIGS. 8A and 8B are diagrams showing a third conduction time shortened by a certain percentage of the normal conduction time and a printing pattern during the third shortened conduction time, respectively.

FIGS. 9A and 9B are diagrams showing a fourth conduction time shortened by a certain percentage of the normal conduction time and a culling mask pattern used during the fourth shortened conduction time, respectively.

### DETAILED DESCRIPTION

According to one embodiment, an image forming apparatus includes a feeding mechanism, an image forming unit, and a control unit. The feeding mechanism is configured to feed a recording medium. The image forming unit is configured to form an image on the recording medium. The control unit is configured to calculate a duty cycle for a print data unit and to control the image forming unit to form the image based on the calculated duty cycle, thereby reducing electrical power consumption for forming the image.

Now, an image forming apparatus and an image forming method of the image forming apparatus in accordance with embodiments of the present disclosure will be described in detail with reference to the accompanying drawings.

An image forming apparatus includes a feeding mechanism, an image forming unit, a RAM (Random Access Memory) as a memory device (or a storing unit), a flash ROM (Read Only Memory) as a rewritable non-volatile memory device, and a control unit. The feeding mechanism is configured to feed a recording medium. The image forming unit is configured to form an image on the recording medium. The control unit is configured to reduce electrical power consumption for a print data unit when a duty cycle for the print data unit is greater than a threshold value.

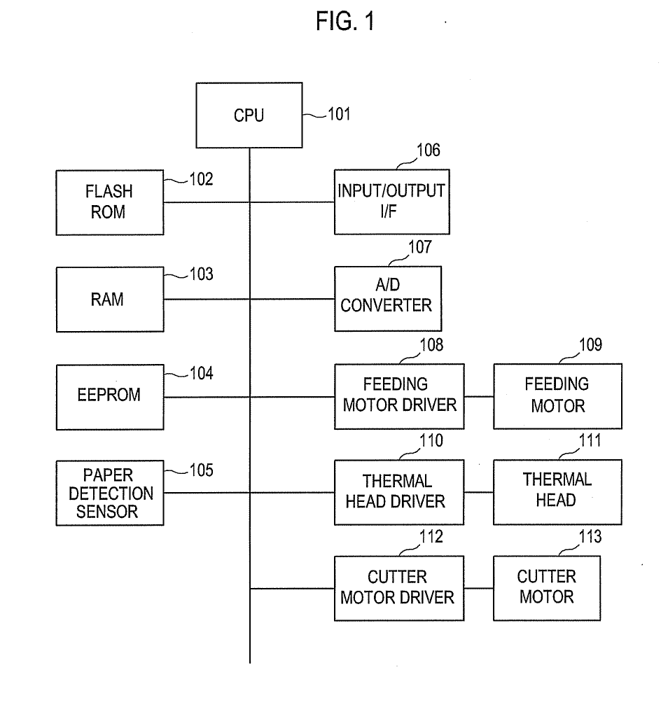

FIG. 1 is a block diagram showing a configuration of the image forming apparatus. The image forming apparatus may include an electronic image forming device such as a laser printer, an ink-jet printer, a dot printer, or a thermal printer. As an example of the electronic image forming device, a thermal printer will be described herein.

As shown in FIG. 1, the image forming apparatus includes a CPU (Central Processing Unit) 101 serving as a control unit, a flash ROM 102 serving as a rewritable non-volatile memory device, a RAM 103 serving as a memory device (or a storing unit), and an EEPROM (Electrically Erasable Programmable Read Only Memory) 104 serving as a rewritable memory device.

The image forming apparatus further includes a paper detection sensor 105, an input/output interface (I/F) 106, and an A/D (analog-to-digital) converter 107. The paper detection sensor 105 is configured to detect the presence or absence of a recording medium. The input/output I/F 106 is a communication interface configured to communicate with an high-level machine such as a personal computer. The A/D converter 107 is configured to convert analog data to digital data.

The image forming apparatus further includes a feeding mechanism (e.g., feeding rollers) configured to feed a recording medium, a feeding motor 109, a feeding motor driver 108, a thermal head 111, a thermal head driver 110, a cutter motor 113, and a cutter motor driver 112. The feeding motor 109 is configured to supply a driving force to the feeding mechanism for feeding the recording medium. The feeding motor driver 108 is configured to control the feeding motor 109. The thermal head 111 serves as an image forming unit to form an image on the recording medium. The thermal head driver 110 is configured to control the thermal head 111. The cutter motor 113 is configured to supply a driving force to a cutter for cutting the recording medium. The cutter motor driver 112 is configured to control the cutter motor 113.

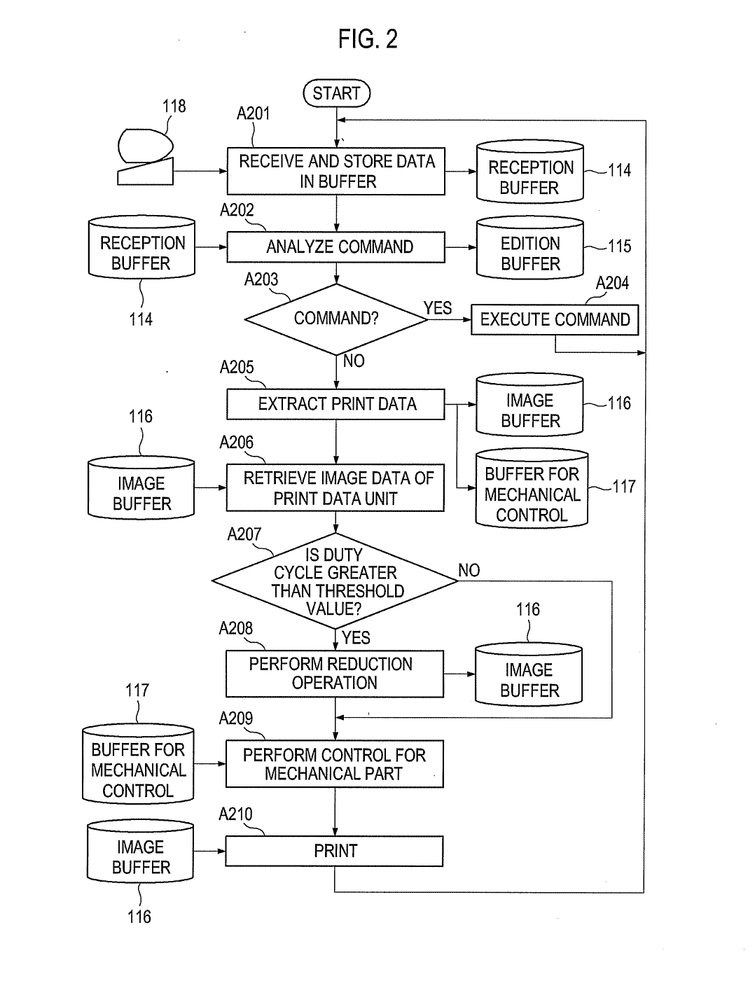

FIG. 2 is a flowchart explaining the operation of an image forming apparatus according to an illustrative embodiment. As shown in FIG. 2, in Act A201, the image forming apparatus receives data from a high-level equipment 118 such as a personal computer, and stores the data (hereinafter referred to as “reception data”) in a reception buffer 114 such as the RAM 103.

In Act A202, the image forming apparatus sequentially reads the data stored in the reception buffer 114. Then, the image forming apparatus analyzes a command contained in the data stored in the reception buffer 114, and outputs the analysis result to an edition buffer 115 such as the RAM 103.

In Act A203, the image forming apparatus reads data (e.g., analysis results) stored in the edition buffer 115 and determines whether the reception data is a command. If the determination result is YES, the image forming apparatus proceeds to Act A204, where the image forming apparatus performs an operation associated with the command, and then returns to Act A201. If the determination result is NO (i.e., the image forming apparatus determines that the reception data is not a command), the image forming apparatus proceeds to Act A205.

In Act A205, the image forming apparatus extracts print data from the reception data, stores image data (e.g., contained in the print data) in an image buffer 116 such as the RAM 103 and further stores mechanical control data (e.g., contained in the print data) in a buffer for mechanical control 117 such as the RAM 103.

In Act A206, the image forming apparatus retrieves image data of a print data unit from the image buffer 116. If the image forming apparatus performs an image forming job in increments of a page, the print data unit may correspond to an amount of image data to cover one page. Alternatively, if the image forming apparatus performs an image forming job in increments of a part of one page, the print data unit may correspond to an amount of image data to cover the part of one page. For example, if one raster of image data in a horizontal direction is 80 bytes and a print data unit includes 100 rasters, the image forming apparatus may retrieve 8000 bytes of image data for the print data unit.

In Act A207, the image forming apparatus calculates a duty cycle for the print data unit and decides whether the duty cycle is greater than a threshold value.

In one embodiment, the duty cycle is calculated by the following Equation:

Duty cycle=(number of printing dots)/(total number of dots for a print data unit) (Equation)

wherein (number of printing dots) denotes a number of dots that are to be actually printed (for the print data unit) on the recording medium through a thermal head being electrically conducted. For example, in a black-and-white printing mode, (number of printing dots) represents a number of dots that are to be printed in black on the recording medium.

In addition, the image forming apparatus may retrieve the threshold value, which is stored in the memory device, in advance. If the calculated duty cycle is greater than the threshold value, the image forming apparatus proceeds to Act A208. Otherwise, the image forming apparatus proceeds to Act A209.

In Act A208, the image forming apparatus performs a reduction operation, which is to be described in detail later, on the retrieved image data and stores the reduced image data in the image buffer 116.

In Act A209, the image forming apparatus retrieves the mechanical control data from the buffer for mechanical control 117 to perform a control for operating a mechanical part to feed the recoding medium.

In Act A210, the image forming apparatus retrieves the image data from the image buffer 116 to print the same, and then returns to Act A201.

In one embodiment, in Act A210, if the reduction operation has been performed, the image forming apparatus may inform the high-level equipment 118 that the reduction operation has been performed.

Now, a first embodiment of the reduction operation will be described in detail. The image forming apparatus reduces the duty cycle by performing a culling (thinning) operation on printing dots. The culling operation may be performed through a culling of printing dots in single dot units or by converting the image data using a mask pattern by which printing dots are culled out. Also, the image forming apparatus changes a culling rate of printing dots depending on the duty cycle for the print data unit.

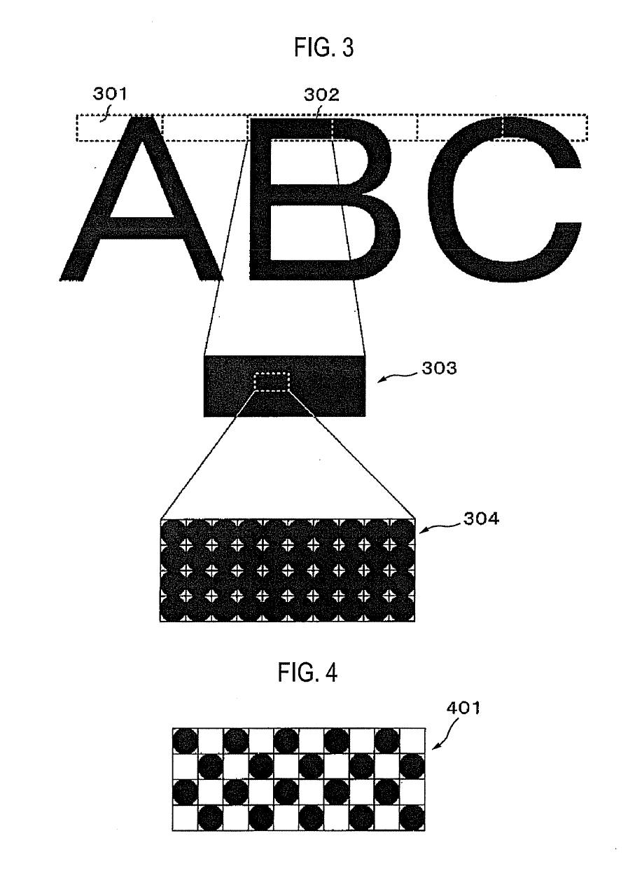

FIG. 3 shows an example state of printing dots prior to performing the culling operation. As shown in FIG. 3, a print data unit 301 has a lower duty cycle while a print data unit 302 has a higher duty cycle. In this example, the duty cycle for the print data unit 302 is assumed to be greater than a threshold value.

Magnifying a portion 303 being printed in solid black in the print data unit 302, the printing dots are densely aggregated as shown in an enlarged view 304.

FIG. 4 shows an example of a culling mask pattern. As shown in FIG. 4, the image forming apparatus generates a culling mask pattern 401 that is created by performing a culling operation on the printing dots.

In one embodiment, the image forming apparatus may perform the culling operation by converting black printing dots to white in an alternating manner. Alternatively, the image forming apparatus may arrange a mask pattern OxAA(•∘•∘•∘•∘) in odd rows and a mask pattern Ox55(∘•∘•∘•∘•) in even rows to thereby generate the culling mask pattern 401.

The culling mask pattern 401 has a culling rate of 50%. With the culling mask pattern 401, the image forming apparatus reduces electrical power consumption by 50%, thereby consuming less electric power in performing an image forming job.

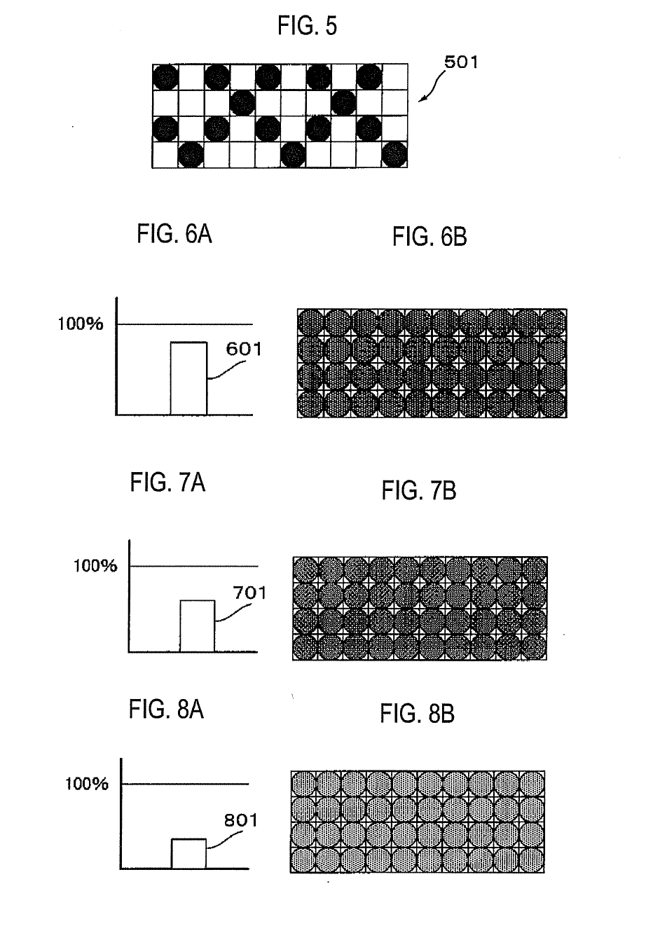

FIG. 5 shows another example of a culling mask pattern. As shown in FIG. 5, if the duty cycle is greater than the threshold value even if a culling operation is performed by employing the culling mask pattern 401, the image forming apparatus may generate a culling mask pattern 501 by additionally performing a culling operation on printing dots of the culling mask pattern 401.

The image forming apparatus then converts a corresponding portion of the image data with the culling mask pattern and stores the converted image data in the image buffer 116.

The following is a detailed description of a second embodiment of the reduction operation. In this embodiment, the image forming apparatus reduces electric power consumption by shortening the conduction time of the thermal head in the image forming unit. If the conduction time is controlled through PWM (Pulse Width Modulation), the image forming apparatus may shorten the conduction time by reducing a duty cycle for PWM.

FIGS. 6A, 7A, and 8A show first to third conduction times shortened by a certain percentage of a normal conduction time, respectively. FIGS. 6B, 7B, and 8B show printing patterns during the first to third shortened conduction times, respectively. The image forming apparatus may reduce electrical power consumption required for an image forming job by an amount correlating to the shortening of a conduction time.

As shown in FIG. 6A, a graph 601 shows the first shortened conduction time corresponding to 70% of a normal conduction time required for a normal image forming job. The printing pattern shown in FIG. 6B, which is printed during the first shortened conduction time, has a slightly lower density compared to a normal printing pattern (e.g., shown in the enlarged view 304).

If the duty cycle is slightly higher compared to a normal printing pattern, e.g., equal to or greater than 60% and less than 70%, the image forming apparatus may adjust the conduction time to 70% of the normal conduction time.

As shown in FIG. 7A, a graph 701 shows the second shortened conduction time corresponding to 50% of the normal conduction time required for the normal image forming job. The printing pattern shown in FIG. 7B, which is printed during the second shortened conduction time, has a lower density compared to the normal printing pattern.

If the duty cycle is high, e.g., equal to or greater than 70% and less than 90%, the image forming apparatus may adjust the conduction time to 50% of the normal conduction time.

As shown in FIG. 8A, a graph 801 shows the third shortened conduction time corresponding to 30% of the normal conduction time required for the normal image forming job. The printing pattern shown in FIG. 8B, which is printed during the third shortened conduction time, has a significantly low density compared to the normal printing pattern.

If the duty cycle is significantly higher, e.g., equal to or greater than 90%, the image forming apparatus may adjust the conduction time to 30% of the normal conduction time.

The image forming apparatus may shorten the conduction time by a preset reduction rate. Alternatively, the image forming apparatus may adjust the reduction rate based on the duty cycle. For example, the reduction rate may be increased as the duty cycle becomes higher.

In a third embodiment, the image forming apparatus may generate a culling mask pattern, and shorten a conduction time of a thermal head while printing by using the culling mask pattern, thereby reducing electrical power consumption. When the conduction time is controlled through PWM, the image forming apparatus may shorten the conduction time by reducing the duty cycle for PWM.

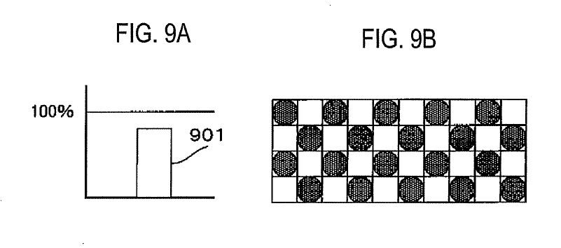

FIGS. 9A and 9B show a fourth conduction time shortened by a certain percentage of a normal conduction time and a culling mask pattern used during the shortened conduction time, respectively. As shown in a graph 901 of FIG. 9A, the fourth shortened conduction time period is 70% of the normal conduction time. Also, the culling rate of the culling mask pattern is 50%.

Accordingly, electrical power consumption required for the image forming job may be reduced up to 35% in comparison with the power consumption for a normal image forming job.

As described above, the image forming apparatus of the above embodiments includes the feeding mechanism for feeding the recording medium, the image forming unit for forming an image on the recording medium, the RAM 103 serving as the memory device, the flash ROM 102 serving as the rewritable non-volatile memory device, and the control unit for performing a reduction operation to reduce electrical power consumption corresponding to image data of a print data unit when a duty cycle of the print data unit is greater than a threshold value.

Therefore, the image forming apparatus may reduce electrical power consumption while maintaining reasonable printing quality.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus, and can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) in the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for forming an image, the apparatus comprising:
a feeding mechanism configured to feed a recording medium;
an image forming unit configured to form an image on the recording medium; and
a control unit configured to calculate a duty cycle for a print data unit and control the image forming unit to form the image based on the calculated duty cycle, thereby reducing electrical power consumption for forming the image.

2. The apparatus of claim 1, wherein the control unit calculates the duty cycle for the print data unit by the following equation:
the duty cycle=(number of printing dots)/(total number of dots for the print data unit)
wherein (number of printing dots) denotes a number of dots that are to be printed on the recording medium through the image forming unit.

3. The apparatus of claim 2, wherein if the duty cycle for the print data unit is greater than a predetermined value, the control unit reduces electrical power consumption for forming the image data of a print data unit.

4. The apparatus of claim 2, wherein if the duty cycle for the print data unit is greater than a predetermined value, the control unit generates a culling mask pattern by culling out printing dots for the image data of the print data unit and converts the image data of the print data unit with the culling mask pattern, thereby forming the image using the converted image data.

5. The apparatus of claim 4, wherein the control unit changes a culling rate of the printing dots based on the duty cycle for the print data unit.

6. The apparatus of claim 2, wherein if the duty cycle for the print data unit is greater than a predetermined value, the control unit adjusts a conduction time required for forming the image using the image data of the print data unit to be shorter than a normal conduction time.

7. The apparatus of claim 6, wherein the control unit changes the conduction time required for forming the image using the image data of the print data unit based on the duty cycle for the print data unit.

8. The apparatus of claim 2, wherein if the duty cycle for the print data unit is greater than a predetermined value, the control unit generates a culling mask pattern by culling out printing dots for the image data of the print data unit and converts the image data of the print data unit with the culling mask pattern, thereby adjusting a conduction time required for forming the image using the image data of the print data unit to be shorter than a normal conduction time.

9. The apparatus of claim 2, wherein the control unit changes a culling rate of the printing dots based on the duty cycle for the print data unit and adjusts a conduction time required for forming the image using the image data of the print data unit based on the duty cycle for the print data unit.

10. The apparatus of claim 1, further comprising:
a communication unit configured to receive data associated with an image forming job from a high-level equipment; and
a storing unit configured to store the received data from the high-level machine.

11. A method of forming an image, the method comprising:
generating, through a control unit, if a duty cycle for a print data unit is greater than a predetermined value, a culling mask pattern by culling out printing dots for the image data of the print data unit;
converting, through the control unit, the image data of the print data unit with the culling mask pattern; and
forming, through an image forming unit, an image using the converted image data on a recording medium.

12. The method of claim 11, wherein the duty cycle for the print data unit is calculated by the following equation:
the duty cycle=(number of printing dots)/(total number of dots for the print data unit)
wherein (number of printing dots) denotes a number of dots that are to be printed on the recording medium through the image forming unit.

13. The method of claim 12, wherein forming an image using the converted image data on a recording medium includes forming an image with electric power consumption reduced based on the duty cycle.

14. The method of claim 12, further comprising:
changing, through the control unit upon generating the culling mask pattern, a culling rate of the printing dots based on the duty cycle for the print data unit.

15. The method of claim 11, further comprising:
receiving, through a communication unit, data associated with an image forming job from a high-level equipment; and
storing, through a storing unit, the received data from the high-level equipment.

16. A method of forming an image, the method comprising:
adjusting, through a control unit, if a duty cycle for a print data unit is greater than a predetermined value, a conduction time required for forming an image using image data of a print data unit to be shorter than a normal conduction time; and
forming, through an image forming unit, the image using the image data of the print data during the shortened conduction time.

17. The method of claim 16, wherein the duty cycle for the print data unit is calculated by the following equation:
the duty cycle=(number of printing dots)/(total number of dots for the print data unit)
wherein (number of printing dots) denotes a number of dots that are to be printed on the recording medium through the image forming unit.

18. The method of claim 16, wherein the conduction time required for forming the image using the image data of the print data unit is shortened based on the duty cycle for the print data unit.

19. The method of claim 16, further comprising:
receiving, through a communication unit, data associated with an image forming job from a high-level equipment; and
storing, through a storing unit, the received data from the high-level equipment.
